(19) United States
(12) Patent Application Publication
(10) Pub. No.: US 2024/0299935 A1
(43) Pub. Date: Sep. 12, 2024

(54) Reagent Delivery System for Microfluidic Chemical Analyzer

(71) Applicant: Fluidion US Inc., Los Angeles, CA (US)

(72) Inventors: Dan E. Angelescu, Pasadena, CA (US); Joyce Wong, Altadena, CA (US)

(21) Appl. No.: 18/178,997

(22) Filed: Mar. 6, 2023

(51) Int. Cl. B01L 3/00

(52) U.S. Cl. CPC B01L 3/502715; B01L 2200/027; B01L 2200/16; B01L 2300/0816; B01L 2300/0867; B01L 2400/0481; B01L 2400/0487

(57) ABSTRACT

A reagent delivery and analysis system for receiving and analyzing a fluidic sample is provided. The system includes one or more reagent storage containers for holding the same or different reagents. A fluidic mixer is coupled to the one or more containers, each container coupled to the fluidic mixer via a different reagent conduit. Each reagent conduit includes a valve controlling flow of reagent from the container to the fluidic mixer. The fluidic mixer is further coupled to a fluid source. The fluidic mixer homogenizes a fluidic sample from the fluid source with reagent. A pressurization module selectively applies a pressure to at least one of the one or more containers via a pressurization fluid that is kept separate from the sample fluid, and to the reagent in the one or more containers. The pressure causes reagent to flow from a selected container into the fluidic mixer.

### TECHNICAL FIELD

The present invention relates to a microfluidic chemical analyzer and, more particularly, to a fluidic system for performing reagent-based chemical measurements, that can accurately control the delivery and mixing of a sample fluid with desired reagent(s).

### BACKGROUND ART

Water quality measurements are often required to ensure compliance with various regulations or operational specifications, to control production processes in industrial operations, to protect public health against exposure to dangerous chemicals or pathogens, or to study natural aquatic environments. Furthermore, water quality control may occur in a wide variety of settings, ranging from drinking water production and distribution (measurements of water quality in production plants, throughout the distribution infrastructure—tanks, pipes, tap etc.), to industrial settings (process water, characterization of influent and effluent from municipal or industrial wastewater treatments etc.), to the natural habitat (measurements of various anthropogenic pollutants in surface and coastal waters, recording ocean acidification trends etc.), and finally to consumer needs (ensuring adequate operation of individual water treatment units, maintaining swimming pools etc.).

Many water quality parameters are measured using different variants of colorimetric protocols. Such protocols involve the mixing of the sample with one or several chemical reagents in controlled ratios, following a well-defined sequence. The protocol may require additional process steps, such as heating the sample, or mechanical agitation to improve the mixing or dissolution of different reagents. Following a chemical reaction involving the chemical compound of interest, the sample-reagent mixture develops a color of an intensity that is related to the concentration of the compound. The color intensity is typically quantified using a spectrophotometer configured to measure absorbance at one or multiple wavelengths that are characteristic to the absorbance curve of the reaction product. Generally, a blank is performed as well, to account for water or reagent coloration which might otherwise be interpreted as presence of the compound of interest. Alternatively, an electrochemical sensor could be used instead of the optical detection.

Such determinations are usually performed in a laboratory setting, on samples that are manually collected at different locations. Manual sampling requires significant logistics in terms of personnel and transportation, the representativeness of the sample depending on the exact sampling procedure used. Samples may require preservation during transport, e.g. by lowering temperature or by adding chemicals to limit the degradation of the compounds of interest. Chain-of-custody records need to be carefully documented to ensure traceability. The sampling, preservation, transportation, documentation, and laboratory protocol implementation are all prone to potential human error that may result in erroneous results. As the number of control points is increased, a laboratory may become overwhelmed by a quantity of samples that overcomes the laboratory throughput capacity. In some cases, relevant sampling locations may be so remote or difficult to access that practical considerations may limit the ability to monitor using traditional techniques. Sample degradation in transport is another critical aspect, which limits a laboratory's ability to monitor certain compounds, such as chlorine levels or pH, which may evolve rapidly and irreversibly due to evaporation or temperature changes. Often such parameters are measured directly in the field, using portable sensors, kits or photometric cuvette tests (portable spectrophotometers and colorimetric measurement kits).

Clean drinking water and sanitation represent one of United Nations' major sustainable development goals, and the World Health Organization (WHO) issued general drinking water quality guidelines (See World Health Organization, “Guidelines for Drinking-Water Quality: Fourth Edition Incorporating the First Addendum” (2014)) that are further reinforced through federal, national or regional regulations that impose limits on various water contaminants, of microbiological or chemical nature. In most of the world, water disinfection in production plants and then residually in the distribution network is ensured through addition of chlorine to the water. Maintaining sufficient chlorine residual from plant to customer tap is essential to ensure that microbiology risks are controlled, and water utilities as well as regulators need to perform frequent controls of chlorine levels. Depending on the specific country, state and municipality, or on the local utility practices, residual disinfection may be implemented using either free chlorine or chloramines, requiring subsequent monitoring of free or, respectively, total chlorine levels. Various phenomena may lead to a decrease in the chlorine levels, such as chlorine consumption by biofilm present in pipes, accidental or intentional pollution, wastewater infiltration in old infrastructures, development of bacterial blooms in the case of networks disinfected with chloramine e.g. through nitrification phenomena in the distribution network etc. In remote or terminal branches of the distribution network, water quality degradation may be compounded by stagnation. Such sites, which are often located furthest from the drinking water plant and laboratory, may require monitoring at increased frequencies, thus generating logistical issues. Usually, for every sample, multiple chemical determinations need to be performed: in a chloraminated water supply, for example, the monitoring protocol may require measuring on every sample pH, total chlorine, free ammonia and nitrite concentration.

In natural settings, water quality is monitored to ensure compliance with federal, national, or state regulations, or as part of specific research or long-term monitoring programs. Critical sampling points are often located in environmentally-sensitive areas, which may be remote. Long travel and holding times can lead to sample degradation during holding and transport, which may in turn lead to inaccurate measurements. Often, pollution is associated with, or amplified by, storm events, which are increasingly violent and unpredictable due to the current climate change trends. Sampling prior, during and after a storm event is critical for understanding the dynamics of such rapid events, and the total amount of associated pollution. Such high frequency sampling is, however, particularly challenging, requiring sampling personnel being deployed to field locations in difficult and potentially dangerous conditions. Recording ocean acidification trends further compounds difficulties, requiring measurements to be performed throughout the planetary ocean, at surface and depth, which is very difficult to implement at global scale with manual sampling and measurement programs.

Water quality monitoring requirements can change at one location over time, or from one location to the next. Depending on the local environment and application, water sample to be analyzed may be at ambient pressure (at the surface of a water body at atmospheric pressure or at depth, at the corresponding hydrostatic pressure), or it may need to be drawn from a pipe, a tank or a reservoir that is maintained at a pressure higher than ambient.

Thus, there is a great need for automated analyzers that are capable to provide water quality data in an automated fashion, operating autonomously in the field and with minimal maintenance requirements. Such an analyzer concept would need to be easily configured to sample from different sources. Furthermore, the analyzer should be able to perform multiple different chemical measurements, and be able to dynamically implement new chemical measurement protocols, or protocols that may require tuning over time. For some chemical reactions, it would be advantageous for the analyzer to be able to control the reaction temperature, which can activate or accelerate the reaction, and thus improve accuracy and reduce measurement duration. The analyzer should not affect the environment, i.e. it should be able to operate while producing no, or only minimal amounts of waste, and should be able to operate for a long time using very small amounts of electrical power (e.g., on battery or, where applicable, on solar power). Long-term operation in natural environments would require an analyzer having the ability to automatically clean itself to remove deposits, biofilm and contamination by solid particles by injecting cleaning solutions or air bubbles.

Microfluidic devices, defined as fluidic devices with sub-millimeter channels of lateral dimension typically ranging from a few micrometers to a few hundreds of micrometers, have demonstrated the potential to integrate various functional modules and thus miniaturize the size of analytical systems, while reducing power as well as chemical reagent requirements. See D. E. Angelescu, “Highly Integrated Microfluidics Design”, ISBN: 9781596939790 (Norwood MA: Artech House, 2011), which is hereby incorporated herein by reference in its entirety). Different microfluidic mixing, reagent injection, optical detection, and implementation mechanisms exist for performing on-chip chemical reactions, for applications ranging from analytical chemistry, to the medical and industrial domains. Manufacturing methods range from soft lithography, to plastic micro-molding, to fabrication in silicon and glass substrates using micro-electro-mechanical systems (MEMS) technology, to name a few. Despite their popularity in academic settings, in certain laboratory instrumentation, and in medical point-of-care devices and tests, the use of microfluidic systems for water quality analysis remains relatively limited.

U.S. Pat. No. 7,799,278, which is hereby incorporated herein by reference in its entirety, discloses a microfluidic sensor comprising a submersible housing and a substrate being partly outside of the housing for recovering the fluid to be analyzed and transferring it to an analyzing device located inside the housing. The sensor is completely immersed in the fluid to be measured, with at least one reagent being at the same pressure as the fluid to be analyzed. A fluid drive means (i.e., a pump), which is internal to the device, is used for circulating the fluid from the fluid body to the housing, the reagent being pulled by its storage compartment by the pressure difference created by the pump, with flow rate being controlled by the pressure difference and the reagent channel geometry. A passive mixer is used to ensure the mixing of sample and reagent. Optical interrogation means consisting of a light source and a detector allows optical measurements of the reaction products. This system is difficult to adapt to new measurements, since the reagent channel geometries are fixed by the substrate and cannot be easily adapted to change the mixing ratio of sample and reagent, and consequently the reagent type. While multiple reagents could in principle be used, the described analyzer cannot measure multiple chemical compounds in a single device, since it misses valves for selecting the specific reagents to be injected. The described analyzer lacks the ability to control sample temperature, or perform auto-cleaning functions. The system also does not allow a blank measurement to be recorded, which affects the resulting accuracy.

U.S. Pat. No. 9,410,894, which is hereby incorporated herein by reference in its entirety, discloses a microfluidic device for analyzing water present in a pressurized pipe, which does not use a pump but instead makes use of the pressure of said pipe, which is higher than the ambient pressure, and employs valves in order to control the flow sample and reagents through the device. Hydraulic constrictions in the sample and reagent channels control their respective flow rates, and a mixer insures their mixing. An optical configuration of light source and detector is coupled to the microfluidic device to allow absorbance measurements to be performed. This device overcomes some of the limitations of U.S. Pat. No. 7,799,278, by being able to implement blank measurements and controlling reagents stored in multiple tanks, thus having the ability to perform multiple chemical measurements in a single device. The reagent tanks are outfitted with separators that transmit the pipe pressure to the actual chemical reagents. The device described can only be used to measure water from a pressurized pipe, as it relies on the existence of a local differential pressure between the inlet (sampling medium) and the outlet (surrounding environment). It cannot be deployed, for example, for measuring environmental samples or samples within the ocean, where such local pressures differentials do not readily exist. Relying exclusively on the externally-controlled pressure of the supply pipe and on hydraulic geometry for controlling the sample and reagent flows, the analyzer can neither allow fine control of the reagent delivery, nor account for the additional pressure required for the deformation of the separators present in the tank. It therefore does not allow fine-tuning the chemical protocols and reagent injection rates, which is required to optimize the measurement range and the analyzer accuracy. The device described also lacks the ability to control sample temperature, or perform auto-cleaning functions.

U.S. Pat. No. 10,261,009, which is hereby incorporated herein by reference in its entirety, discloses a disposable mobile microfluidic device for determining an analyte in a water sample, consisting of a test element containing channels pre-loaded with one or multiple chemical reagents. The test element can be loaded in an external unit that is able to draw a sample, the mixing of the sample with the reagents pre-disposed in the channels being achieved passively. The mixture is read optically or using an electrochemical arrangement, either measurement performed by the external unit. The device disclosed does not provide means for controlling the renewed delivery of the sample and reagent, or for their disposal, and therefore it is limited to occasional field measurements, being unsuitable for continuous in-line monitoring.

### SUMMARY OF THE EMBODIMENTS

In illustrative embodiments, a fluidic system and methodology for performing reagent-based chemical measurements, that accurately controls the delivery of a sample stream and its accurate mixing with one or multiple reagents, is provided. The system may also be able to perform auto-cleaning functions, and control chemical reaction temperatures. The fluidic system may, in various embodiments, be implemented using microfluidic technology.

In accordance with an embodiment of the invention, a reagent delivery and analysis system for receiving and analyzing a fluidic sample is provided. The system includes one or more reagent storage containers for holding the same or different reagents. A fluidic mixer is coupled to the one or more containers, each container coupled to the fluidic mixer via a different reagent conduit. Each reagent conduit includes a valve controlling flow of reagent from the container to the fluidic mixer. The fluidic mixer is further coupled to a fluid source. The fluidic mixer homogenizes a fluidic sample from the fluid source with reagent. A pressurization module selectively applies a pressure to at least one of the one or more containers via a pressurization fluid that is kept separate from the sample fluid, and to the reagent in the one or more containers. The pressure causes reagent to flow from a selected container into the fluidic mixer.

In accordance with related embodiments of the invention, each reagent conduit may further include a hydraulic resistor. The system may further include a sample pressure sensor, which may be a differential sample pressure sensor configured to measure the pressure difference between the fluid source entering the fluidic mixer and the ambient pressure, or an absolute pressure sensor configured to measure the pressure of the fluid source entering the fluidic mixer. The pressurization module may be configured to selectively apply pressure to at least one of the one or more containers that is calculated based on the pressure sensed by the sample pressure sensor. Each reagent conduit may include a specific hydraulic resistor, and the pressurization module may be configured to selectively apply a pressure to at least one of the one or more containers so as to ensure a desired flow rate of the reagent through its associated hydraulic resistor into the fluidic mixer, and is at least partially based on the pressure measured by the sample pressure sensor and the value of the associated hydraulic resistor.

In further related embodiments of the invention, the system may include a sample analysis module for analyzing the homogenized mixture of the fluid sample and the at least one of the one or more reagents. Each reagent conduit and sample may further include a hydraulic resistor, and wherein the fluidic mixer, each hydraulic resistor, and/or the sample analysis module may include microfluidic devices with lateral channel dimensions between 1 and 1000 micrometers, and/or may include devices manufactured using Microelectromechanical Systems (MEMS) technology.

In accordance with still further embodiments of the invention, the pressurization fluid may be a gas, and the system may further include a pressurized gas source coupled to an inlet port of a manifold, the manifold including a pneumatic pressure sensor configured to measure the pressure of the gas in the manifold. The manifold includes a pressure release port for allowing the gas to escape the manifold, the manifold further including one or more outlet ports that are pneumatically coupled to the one or more containers. The manifold further includes on-off valves for controlling pneumatic connectivity from the inlet port of the manifold to the pressure release port and to the one or multiple outlet ports, said on-off valves being controlled by the pressurization module based, at least in part, on the measured pressure of the gas in the manifold. The pressurized gas source may include an air pump, the air pump controlled by the pressurization module so as to maintain a predetermined pressure setpoint value at the pneumatic pressure sensor.

In accordance with yet further related embodiments of the invention, each container may be positioned within a pressure housing, the pressurization fluid applying pressure to the pressure housing which in turn is transmitted to the reagents. The pressure housing may further include a separator between the reagent and the pressure fluid that prevents their contact but still allows the transmission of the pressure from the pressurization fluid to the reagent. The separator may include a compliant partition or a threaded bag.

In accordance with another embodiment of the invention, a method of receiving and analyzing a fluidic sample is provided in which one or more reagent storage containers are coupled to a fluidic mixer. Each container is coupled to the fluidic mixer via a different reagent conduit, with each reagent storage container configured to hold the same or different reagent. The method includes controlling flow of a sample fluid from a fluid source into the fluid mixer; selectively applying a pressure to at least one of the one or more containers via a pressurization fluid that is kept separate from the sample fluid, and to the reagent in the one or more containers, resulting in the pressure causing reagent to flow from a selected container into the fluidic mixer; and homogenizing, by the fluidic mixer, the sample fluid with reagent.

In accordance with related embodiments of the invention, each reagent conduit may be associated with a valve controlling flow of the reagent from the container to the fluidic mixer, the method further comprising controlling the valve to allow flow of the reagent from the container to the fluidic mixer. Each reagent conduit may further include a hydraulic resistor.

In accordance with further related embodiments of the invention, the method may include measuring a sample pressure selected from one of a differential sample pressure between the fluid source entering the fluidic mixer and the ambient pressure, and an absolute pressure of the fluid source entering the fluidic mixer. Selectively applying pressure to at least one of the one or more containers may include applying a pressure calculated based on on the sample pressure. Each reagent conduit may further include a specific hydraulic resistor, and wherein selectively applying a pressure to at least one of the one or more containers includes ensuring a desired flow rate of the reagent through its associated hydraulic resistor into the fluidic mixer, and is at least partially based on the sample pressure and the value of the associated hydraulic resistor. The method may further include analyzing the homogenized mixture of the fluid sample and the at least one of the one or more reagents.

In accordance with still further related embodiments of the invention, selectively applying a pressure to at least one of the one or more containers via a pressurization fluid that is kept separate from the sample fluid may include: coupling a pressurized gas source to an inlet port of a manifold, the manifold including a pressure release port for allowing the gas to escape the manifold, the manifold further including one or more outlet ports that are pneumatically coupled to the one or more containers, the manifold further including on-off valves for controlling pneumatic connectivity from the inlet port of the manifold to the pressure release port and to the one or multiple outlet ports; measuring the pressure of the gas in the manifold; and controlling said on-off valves based, at least in part, on the measured pressure of the gas in the manifold. The pressurized gas source may include an air pump, the method further comprising controlling the air pump so as to maintain a desired pressure setpoint value in the manifold.

In accordance with yet further related embodiments of the invention, the container may include a pressure housing, and wherein selectively applying a pressure to at least one of the one or more containers via a pressurization fluid includes applying pressure to the pressure housing which in turn is transmitted to the reagents. The pressure housing may further include a separator between the reagent and the pressure fluid that prevents their contact but still allows the transmission of the pressure from the pressurization fluid to the reagent. The separator may include a compliant partition or a threaded bag.

In accordance with another embodiment of the invention, a fluidic system for performing fluid analysis is provided. The fluidic system includes (a) a sample delivery module, (b) a pressurization module, (c) a sample analysis unit and (d) a central control module, which coordinates the operation of the system and communicates with the other units and modules, as well as with remote equipment such as, for example, a computer terminal, a cell phone or tablet, a communication satellite, a server for data visualization and remote system control, or a supervisory control and data acquisition (SCADA) interface.

In accordance with related embodiments of the invention, the sample delivery module is responsible for providing a clean, representative sample stream/fluidic sample, at a pressure that is higher than the ambient pressure of the environment where the fluidic system is deployed, and that is compatible with the subsequent modules and units. Such a pressure may be a few psi (a fraction of a Bar) to a few tens of psi (a few Bar) higher than the ambient pressure, typically in the range of 3-15 psi higher than ambient pressure (0.2-1.0 Bar). In the case in which the sample fluid is at ambient pressure, the sample delivery module may include a sampling pump, such as, without limitation, a peristaltic pump, a positive displacement pump, or a diaphragm pump, means such as a flushing valve to flush the sampling lines to ensure representativeness of the sample, as well as means for controlling the pressure of the output sample stream. Alternatively, if the sample fluid is located within a conduit pressurized at a pressure higher than ambient, the sample delivery module may include a flushing valve to flush the sampling lines, combined with appropriate control of the pressure of the output sample stream. After exiting the sample delivery module, sample flow is driven by the pressure in a purely passive way, the sample flow rate typically being proportional to the pressure generated by the sample delivery module and inversely proportional to the hydraulic resistance of the subsequent fluidic blocks.

In accordance with further related embodiments of the invention, the sample stream exiting from the sample delivery module enters the analyzer block, which is responsible for controlling the sample stream/fluidic sample flow, the controlled injection of one or multiple reagents in well-defined quantities and their thorough mixing with the sample stream, the temperature control of the sample and reagents mixture (if required), and their analysis using optical or electrochemical protocols. The analyzer block therefore includes the reagent delivery unit, which is connected via reagent conduits or capillaries with the reagent storage units, themselves controlled by a pressurization module. The reagent delivery unit may also include a mixer for homogenizing the mixture of reagents and fluidic sample/stream. A passive mixer based on laminar mixing may be used in a microfluidic implementation. Such a mixer could be manufactured using MEMS of microfluidic manufacturing techniques. A pressure sensor, located either within the reagent delivery unit or immediately upstream of it, may communicate the sample stream/fluidic sample pressure to the pressurization module, which in turn may use an air pump to generate pneumatic pressure and pressurize the reagent storage units, and therefore the reagents, at a pressure that is equal to or slightly higher than the sample pressure.

In accordance with still further embodiments of the invention, valves may be located on the reagent storage units or in the reagent delivery unit to control the timing and duration of reagent injection for each reagent, whereas the individual injection rate is controlled by individual hydraulic resistors located within the reagent storage units or within the reagent delivery unit. The location of the reagent valves may be within the reagent delivery unit, whereas the location of the hydraulic resistors may be within the reagent storage unit, which allows each resistor to be uniquely tied to the corresponding reagent. This way, the reagent storage units may become interchangeable, since the flow rate of each reagent is fully determined by components located within the actual reagent storage units, and by the controlled pneumatic pressure.

In accordance with yet further related embodiments of the invention, the reagent storage units may be reusable or disposable. They may include collapsible bags for storing the reagents, the pneumatic pressure generated by the pressurization module being transmitted to the reagents through the compliant walls of the collapsible bags, without direct contact between the pressurized air and the reagents. Alternatively, instead of actual chemical reagents, some of the reagent storage units may include cleaning or disinfecting solutions, that may be injected periodically in order to decontaminate, clean and remove scaling or biofilm that may develop in the reagent delivery unit and sample analysis module. Such solutions may include acidic or basic chemical mixtures, organic solvents, and/or oxidizing solutions such as bleach. Alternatively, the pneumatic pressure may be used to periodically inject bubbles into the reagent delivery unit, which then can help remove debris and clean the sample analysis module. Another advantage of having ability to inject bubbles is that they help segment the flow downstream of the injection point, which can result in faster cleanup of previous reaction products.

In accordance with still further embodiments of the invention, the reagent storage units may be outfitted with a form of non-volatile remotely-readable and writable memory for storing parameters related to the reagent storage unit as well as analyzer programs, which can be accessed wirelessly by the reagent control module. Different forms of RFID tags exist today allowing to implement such functionality. The non-volatile memory may contain important information regarding, for example and without being exhaustive: reagent code; manufacturing date; expiry date; available reagent volume (or number of cycles); date of installation in the current analyzer; volume (or number of measurement cycles) performed so far. The non-volatile memory could be read by the reagent control module prior to every measurement, allowing the analyzer to warn the user when a reagent is expired or depleted, or when a related required reagent is missing. The analyzer can thus avoid running a measurement if it risks producing unreliable data or damaging the analyzer. After the measurement, the updated reagent information (such as remaining reagent quantity and the number of measurement cycle performed) may be written back into the non-volatile memory. The non-volatile may also enable the analyzer to detect when a reagent is changed with a different type of reagent, and adapt its measurement protocol accordingly. The non-volatile memory may furthermore contain the analyzer program for performing the specific measurement protocol, using sequences of individual operations defined in an analyzer programming language.

In accordance with further related embodiments of the invention, the output of the reagent delivery unit, including the homogenized reagent and fluidic sample mixture, flows into the sample analysis module, where measurements are performed. The sample analysis module may include an optical sensor to measure absorbance at wavelengths that are specific to the chemical reaction products, or may contain an electrochemical cell with a specific configuration of electrodes that would allow an electrochemical measurement to be performed. In various embodiments, the sample analysis module includes a fluidic device having a channel with a light source and a light detector coupled at opposite ends of said fluidic channel, in such a way that light from the source can propagate along the channel, be absorbed by the colored compounds in the channel before reaching the detector at the opposite side. The light source and detector may be coupled to the fluidic channel through optical waveguides, or using optical fibers. The light source may be monochromatic, or filtered so only certain wavelength ranges can propagate. The optical detector may include a photodiode, a phototransistor, an integrated CMOS light sensor, and/or any other sensor or device capable to measure the intensity of the received light. Alternatively, a broadband light source may be used, with a filter located at the detector level, or a multiple-wavelength integrated CMOS detector may be used. Many other possible optical configurations known in the art may be utilized.

In accordance with further embodiments of the invention, the sample analysis module may include valves for isolating the sample within the module for the duration of the chemical reaction and measurement. The sample analysis module may also include a heater and a temperature sensor, connected in a closed feedback loop, to control the reaction temperature of the mixture sample and reagents.

In accordance with still further related embodiments of the invention, the sample analysis module may include a microfluidic chip manufactured using MEMS technology out of resilient materials such as glass and silicon, and including optical fibers adhesively bonded at either extremity of the straight channel, and coupled to the light source and detector, respectively. The adhesive for bonding the fibers may be an epoxy-type resin, a UV adhesive, a silicone, or another type of adhesive known in the art. In a related configuration, the microfluidic chip may be manufactured using hard plastic materials. These proposed configurations have the advantage of automatically aligning the optical fiber within the channel, and therefore with each other, which optimizes their coupling. Additional optical features may be included either in the channel geometry or in the optical fiber endings, such as collimating lenses. Manufacturing the sample analysis module using MEMS silicon/glass technology has the added advantage of allowing heater and temperature sensor elements to be photolithographically patterned onto the same chip, thus achieving high functional integration.

In accordance with yet further related embodiments of the invention, the output of the sample analysis module may split into two streams, controlled by individual valves: a first valve opening to a clean sample outlet, having a first (ideally lower) hydraulic resistance and used for rapidly flushing the sample analysis module with sample fluid without reagents, and a second valve opening to a chemical waste outlet and having a second (ideally higher) hydraulic resistance, for performing measurements with chemical reagents in controlled, low-flow conditions that minimize the resulting waste volume.

In accordance with still further embodiments of the invention, the analyzer may be configured to interpreting measurement protocols encoded according to an analyzer programming language, which can be decoded by the analyzer and executed. The analyzer may perform the different individual unitary operations programmed in the protocol, in the right order, measure the raw signal values, and calculate the measured parameter value according to a recorded mathematical formula and calibration. Typical individual operations accepted in the analyzer program may include, but are not limited to:
specifying the name of the protocol
specifying the parameter name and reporting units
specifying the codes of the required reagents for the measurement to be performed
turning on or off the sampling pump, in case the analyzer is deployed to collect samples in ambient pressure conditions
opening or closing valves, such as the sampling line flushing valve or the sample analysis module flushing valve
opening or closing a valve controlling the sample stream
pressurizing a specific reagent storage unit at a given pressure, by specifying the absolute pressure, or, alternatively, the relative or the absolute offset in relation to the measured sample pressure
depressurizing a specific reagent to ambient pressure
opening or closing a valve corresponding to a specific reagent valve
waiting for a specified amount of time
establishing the temperature setpoint and enabling temperature control of the sample analysis module
setting the current for a specific LED light
turning a specific LED light on or off
setting the gain and integration time for the optical detector
starting an optical measurement at a specific wavelength and recording the measured light intensity value in a specific register
setting the parameters of an electrical measurement (voltage applied or current injected, frequency, specific electrodes used etc.)
starting an electrical measurement and recording the measured voltage or current value in a specific register
computing specific mathematical unitary operations (additions, subtractions, divisions, multiplications, applying trigonometric functions, logarithms) using values stored in specified registers or values provided in the program, and recording the result in another specific register

### BRIEF DESCRIPTION OF THE DRAWINGS

The foregoing features of embodiments will be more readily understood by reference to the following detailed description, taken with reference to the accompanying drawings, in which:

FIG. 1 is a general schematic diagram of the fluidic system, in accordance with an embodiment of the invention;

FIG. 2 shows a sample delivery module, configured for sampling from a pressurized pipe and delivering a clean pressure-controlled sample stream to the analyzer block, in accordance with an embodiment of the invention;

FIG. 3 shows a sample delivery module, configured for sampling from a water source located at ambient pressure and delivering a clean pressure-controlled sample stream to the analyzer block, in accordance with an embodiment of the invention;

FIG. 4 shows a reagent delivery unit for injecting and mixing reagents with the sample stream in controlled proportions, in accordance with an embodiment of the invention;

FIG. 5 shows a diagram of a reagent storage unit, configured to deliver reagent pressurized by a pneumatic source, in accordance with an embodiment of the invention;

FIG. 6 shows a pressurization module, configured to provide a controlled pneumatic pressure to the different reagent storage units, in accordance with an embodiment of the invention;

FIG. 7 shows a sample analysis module configured for performing optical measurements, in accordance with an embodiment of the invention;

FIG. 8 shows a sample analysis module configured for performing electrochemical measurements, in accordance with an embodiment of the invention;

FIG. 9 shows a sample analysis module configured for performing optical measurements, additionally showing the optical components coupled using optical fibers as well as thin film heater and temperature detector elements for temperature control, in accordance with an embodiment of the invention;

FIG. 10 shows a sample analysis module with two different output streams that can be selected using valves: one for clean sample to rapidly flush the module, and one for chemical waste, in accordance with an embodiment of the invention; and

FIG. 11 shows a flowchart of an exemplary program outlining the sequence of individual operations for performing a specific measurement that could be automatically read and executed by the analyzer, in accordance with an embodiment of the invention.

### DETAILED DESCRIPTION OF SPECIFIC EMBODIMENTS

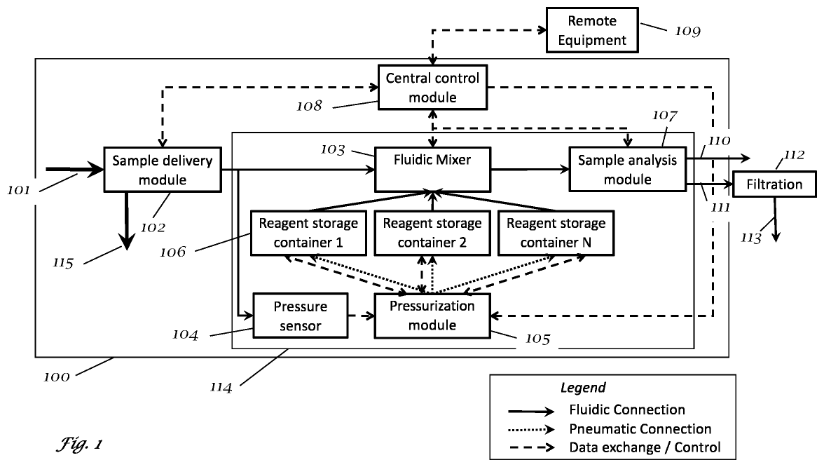

FIG. 1 shows a schematic diagram of a chemical analyzer 100, in accordance with an embodiment of the invention. The chemical analyzer 100 includes a sampling line 101 that allows sample to reach a sample delivery module 102, that can flush the sampling lines to a flush outlet 115 so as to provide a filtered representative sample stream/fluidic sample to the analyzer block 114. As indicated in the legend to FIG. 1, all fluidic lines (for sample and reagents) are shown with solid line arrows, pneumatic lines as dotted line arrows, and data exchange and control connection as dashed line arrows.

The analyzer block 114 consists of a fluidic mixer 103, a pressure sensor 104, a pressurization module 105, one or several reagent storage containers 106, and a sample analysis module 107. Fluidic and pneumatic connections may exist between the different units and modules comprising the analyzer block 114. Data and control connections may exist between the different components of the analyzer block, and also with the analyzer's central control module 108.

The sample stream pressure at the inlet, or immediately upstream, of the fluidic mixer 103 is measured using a pressure sensor 104, which transmits the measured value to a pressurization module 105. The pressurization module can generate controlled pneumatic pressure using an air pump or a pressurized gas supply, which is transmitted, via pneumatic tubes or conduits, to specific reagent storage container 106. The pressurization module can also exchange data with the reagent storage units, such as to control their respective reagent valves. The reagent storage containers 106 are responsible for delivering reagents to the fluidic mixer 103, at a flow rate that is controlled by the pneumatic pressure provided by the pressurization module 105, and by the hydraulic resistance of the corresponding reagent lines/conduits. The fluidic mixer 103 homogenizes the mixture of sample and reagents, and delivers it to the sample analysis module 107.

The pressure sensor 104 may be configured to measure sample stream pressure relative to a vacuum reference, or relative to the ambient pressure. In particular embodiments, the pressure sensor 104 is a differential pressure sensor configured to measure the pressure difference between the inlet and the outlet of the system.

The sample analysis module 107 is responsible for implementing the actual measurement on the sample, which could be of an optical or electrochemical nature. It may contain different subcomponents required for implementing said measurement, such as, for example: light sources, light detectors, optical fibers, waveguides, signal generators, electronic circuits for measuring voltage and current, filter circuits. It may also implement temperature control of the sample and reagent mixture, so as to activate or accelerate a chemical reaction.

The sample analysis module 107 may optionally have several outlets, such as a clean sample outlet 110, which is used for flushing the module with clean water, and a waste outlet 111 which collects the mix of sample and chemical reagents. The waste outlet 111 may be connected to a filtration unit 112, which could be any filter that can remove chemical contaminants from water, such as, for example, an activated carbon filter. The purified waste stream 113 may be released, or collected.

The chemical analyzer 100 may also contain a central control module 108, which communicates with all the other modules present as well as with optional connected remote equipment 109. The central control module 108 coordinates the operation of the different modules present in the chemical analyzer, executes the programs required for performing specific chemical measurements, receives and implements configuration information from connected remote equipment 109, and transmits measurement results to the equipment 109.

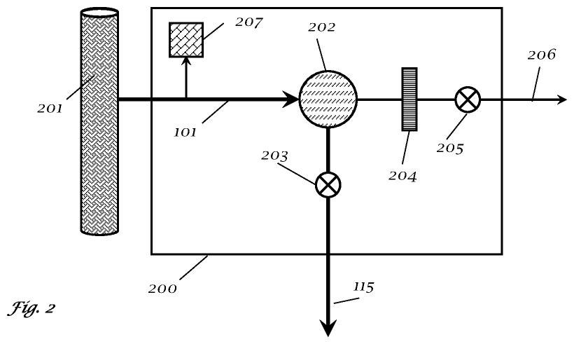

FIG. 2 shows a sample delivery module 200, in a configuration that is adapted for sampling from a pressurize pipe 201 and delivering a fluidic sample via a clean pressure-controlled sample stream outlet 206 to the analyzer block, in accordance with an embodiment of the invention. A pressure-reducing device 202 may be used to reduce the sample pressure from the pressure in the pipe 201 to a controlled pressure compatible with the operation of the analyzer block. Such a pressure may be, without limitation, a few psi (a fraction of a Bar) to a few tens of psi (a few Bar) higher than the ambient pressure, ideally in the range of 3-15 psi higher than ambient pressure (0.2-1.0 Bar). The device 202 may be any type of pressure-reducing regulator known in the art, or it could involve a backpressure regulator preceded by the thin capillary allowing for viscous pressure reduction, the output of which will then be controlled by the setting of the backpressure regulator. A flush valve 203 may be used to rapidly flush the sample line 101 to a flush outlet 115, so as to ensure that a representative water sample reaches the pressure-reducing device 202 and is then directed in the fluidic sample going to the analyzer body via sample stream outlet 206. A filter 204 may be used to remove suspended particulate matter from the fluidic sample. The filter 204 needs to have sufficient filtering capacity so as to be compatible with the operational specifications of the analyzer. Filter 204 could be a large-capacity inline filter, such as a glass microfiber filter, which can be acceptable for relatively clean fluids such as drinking water. Alternatively, the filter 204 could be disposed in tangential filtration configuration, which is less prone to fouling compared to dead-end inline filters. A sample stream valve 205 may be provided on the outlet line 206, to control the delivery of the fluidic sample to the analyzer body. An optional pressure sensor 207 in hydraulic connection with the sampling line 101 may be used to measure the line pressure in pipe 201, by closing the flush valve 203 and the sample stream valve 205.

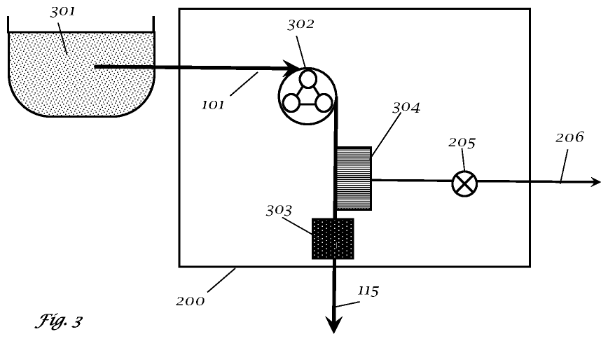

FIG. 3 shows a different embodiment of the sample delivery module 200, this time configured for sampling from a water source 301 located at ambient pressure, and delivering a clean pressure-controlled sample stream 206 to the analyzer block, in accordance with an embodiment of the invention. The sampling line 101 is shown connected to the inlet of a water pump 302, which is configured to pump water from the water source 301 and pump it through a backpressure regulator 303, further connected to a flush port 115. The water pump 302 can be, without limitation, any of a peristaltic pump, a positive displacement pump, or a diaphragm pump. Many types of backpressure regulators exist and are known in the art, and any of them could be used. The pressure setpoint of the backpressure regulator needs to be chosen so as to be compatible with the operation of the analyzer block, typically ranging from a few psi (a fraction of a Bar) to a few tens of psi (a few Bar) higher than the ambient pressure, ideally in the range of 3-15 psi higher than ambient pressure (0.2-1.0 Bar). The sample stream may be filtered through filter 304, ideally deployed in tangential filtration configuration.

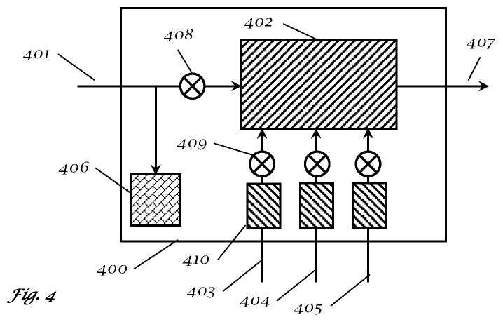

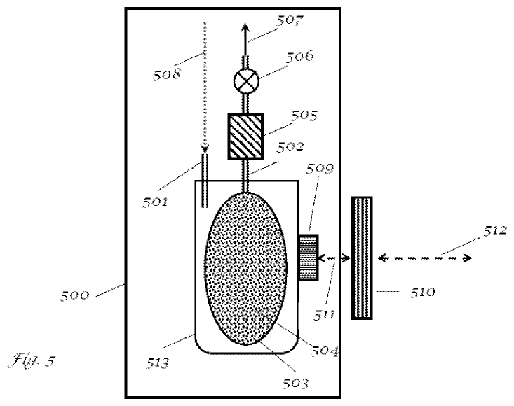

FIG. 4 displays a possible implementation of the reagent delivery module 400, for injecting and mixing reagents with the fluidic sample in controlled proportions. The sample stream is directed from the inlet 401 to, without limitation, a passive fluidic mixer 402 (an active mixer may also be used), that also accepts one, or several, reagent streams via reagent conduits 403, 404, 405. Each container may be coupled to the fluidic mixer 402 via its own reagent conduit 403, 404, 405, however, where appropriate, containers may share a reagent conduit. Additional reagent conduit streams of cleaning solutions may also be connected to the fluidic mixer 402. Any of the passive mixing techniques known in the art may be used in fluidic mixer 402 to deliver a homogenized mixture of sample and reagents to the outlet 407. In a preferred embodiment, the fluidic mixer 402 uses a flow-folding mixing geometry. A pressure sensor 406 may be located near, or just upstream of, the inlet 401, so as to measure the pressure of the sample stream. In a particular embodiment, the pressure sensor 406 may be of a differential type and measure the difference between the pressure at the inlet 401 and the outlet 407. In another embodiment, the pressure sensor 406 may be of a differential type and measure the difference between the pressure at the inlet and the ambient pressure of the environment where the analyzer is deployed. A valve 408 may also be located on the sample stream, so as, for example, to stop the flow of the fluidic sample when cleaning solutions are injected. A valve 409 and a hydraulic resistor 410 may be implemented inside the reagent delivery unit 400, such as within reagent conduits 403, 404, and 405, for controlling the injection and, respectively, the flow rate of the different reagents or cleaning solutions. Alternatively, the reagent control valves 409 or the hydraulic resistors 410 for the different reagents, or both, could be located in the reagent conduits on reagent storage unit 500 (see FIG. 5). In various configurations, the reagent valve 409 is located in the reagent delivery unit, while the hydraulic resistor is located on the reagent storage unit. In a related embodiment, the hydraulic resistor 410 is a removable component. In a further related embodiment, the hydraulic resistor 410 is adjustable.

The hydraulic resistors are essentially well-defined flow restrictors that may provide stronger restrictions to flow than other fluidic elements in the analyzer. The flow of a liquid through a hydraulic resistor is generally laminar. The hydraulic resistors could be portions of capillary tubing of controlled geometry (diameter and length), or they may be manufactured on a solid planar substrate in the form of a microfluidic chip with etched or molded channels of a particular geometry. The flow of an incompressible Newtonian fluid, such as water, through a hydraulic resistor in the laminar regime is such that the flow rate is directly proportional to the pressure difference across the resistor, and indirectly proportional to the viscosity of the fluid.

FIG. 5 shows a possible implementation of a reagent storage unit 500, configured to deliver reagent to the reagent delivery unit 400. The reagent storage unit 500 is made from a pressure-resistant housing 513, that has a pneumatic inlet 501 which can be pressurized using gas from a pneumatic line 508 at a pressure that is controlled by the pressurization module 600 (see below). The reagent storage unit 500 may further be comprised of a reagent outlet 502 and a reagent conduit 507, which are connected in a leakproof manner to a container 503, which is located inside the pressure-resistant housing 513 and is filled with chemical reagent 504. The container 503 should ideally be made of compliant materials that can transmit to the reagents the pneumatic pressure from within the pressure-resistant housing 513, without direct contact between the reagents 504 and the pressurized gas. In an illustrative configuration, the container 503 is a threaded collapsible bag. Other possible implementations (without limitation) include a thin rubber bag, a sliding piston arrangement or a configuration using bellows. The reagent storage unit 500 may also include a hydraulic resistor 505 for controlling the reagent flow rate, and valve 506 for controlling the timing and duration of the reagent injection. As explained above, in a preferred configuration, the reagent valve is located in the reagent delivery unit, whereas the hydraulic resistor 505 is located on the reagent storage unit 500.

The reagent storage unit 500 may also contain a non-volatile remotely-readable and writable memory 509, used for storing parameters related to the reagent storage unit as well as analyzer programs. In a preferred configuration, the memory 509 is an RFID tag that can be read and written by an external RFID module 510, using a proximity wireless data connection 511, without requiring an electrical connection. Different forms of RFID tags exist today allowing to implement such functionality. The external RFID module 510 is itself in data communication 512 with the reagent control module 600, or directly with the central control module 108. The non-volatile memory 509 could contain important information regarding, for example and without being exhaustive: reagent code; manufacturing date; expiry date; available reagent volume (or number of cycles); date of installation in the current analyzer; volume (or number of measurement cycles) performed so far. The non-volatile memory 509 could be read by the reagent control module 105 prior to every measurement, allowing the analyzer 100 to detect when a reagent is expired or depleted, or when a related required reagent is missing. After the measurement, the updated reagent information (such as remaining reagent quantity and the number of measurement cycle performed) can be written back into the non-volatile memory 509, such that the reagent storage unit 500 always contains the most up-to-date information about its contents. The non-volatile can also enable the analyzer to detect when a reagent is changed with a different type of reagent, and adapt its measurement protocol accordingly. The non-volatile memory could furthermore contain the analyzer program for performing the specific measurement protocol, using sequences of individual operations defined in a specific analyzer programming language.

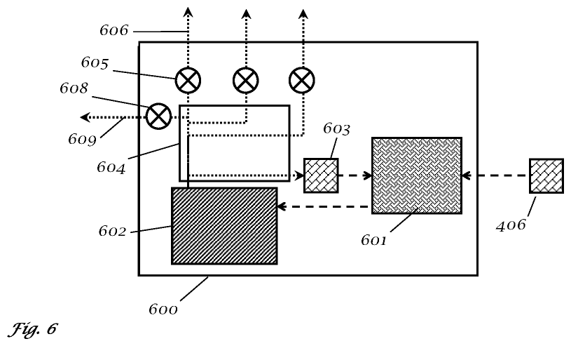

FIG. 6 shows a possible implementation of a pressurization module 600, configured to provide a controlled pneumatic pressure to the different reagent storage units, or to inject pressurized gas into the sample stream for cleaning purposes, in accordance with embodiments of the invention. It may include a control unit 601, such as a microprocessor or microcontroller, capable to control an air pump 602 whose output is connected to a pneumatic manifold 604. Alternatively, instead of the internal air pump 603, an external pressurized air supply could be used, in which case the control unit 601 may control a valve for gradually allowing the entry of pressurized air into the manifold 604. The control unit 601 may have data communication with the pressure sensor 406 for measuring the sample stream pressure, either directly, or via the central control module. It may also be in communication with an internal pressure sensor 603, which measures the pressure of the pneumatic manifold 604. Alternatively, the internal pressure sensor 603 may be a differential sensor, that measures the difference between the pneumatic manifold and the outlet 407, or between the pneumatic manifold and the ambient pressure of the environment surrounding the analyzer. The control unit 601 is therefore capable of operating the pump 602 so as to increase the pressure in the manifold 604 to a given setpoint and control it in a closed feedback loop, based on input from the internal pressure sensor 603. The pressure setpoint may be established in absolute pressure terms, or it may be specified relative to the sample stream pressure, and may include a pressure offset (e.g. the setpoint could be equal to the sample stream pressure, or, for example, 1 psi higher, or 10% higher). The pressure offset may be chosen to equal or slightly higher than the pressure required to overcome the static rigidity of the container 503 and cause its deformation. The pneumatic manifold 604 has an outlet 609, controlled by a valve 608, that allows it to release air to the outer environment, and thus to lower the pressure in the manifold. The pneumatic manifold 604 has one or multiple additional pneumatic outlets 606, controlled by valves 605, that are connected to reagent storage units 500 (to control the injection of the reagents), or directly to the sample stream line, to inject bubbles for cleaning or flushing purposes. The pneumatic manifold may include, instead of a pump, a connection to a gas or air supply of known pressure, such as a regulated compressed air source.

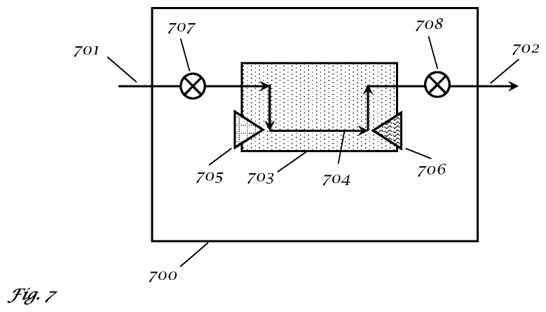

FIG. 7 shows one possible implementation of a sample analysis module 700, configured for performing optical absorbance measurements on the sample stream/fluidic sample 701 (referred hereinafter as fluidic sample 701) Fluidic sample 701 may be controlled by optional valves 707 and 708, which allow complete isolation of the fluid sample during the measurement. The reagent-sample mixture from the outlet 702 may be stored and collected later. The sample analysis module is shown including a fluidic device 703, comprising of, without limitation, a straight fluidic channel 704 with a light source 705 and a light detector 706 coupled at opposite ends of said fluidic channel, in such a way that light from the source 705 can propagate along the channel, be absorbed by the colored compounds from the fluidic sample, before being measured by the detector 706 at the opposite side. The light source 705 may be monochromatic, or filtered so only certain wavelength ranges are emitted. The optical detector 706 may include a photodiode, a phototransistor, an integrated CMOS light sensor, or any other sensor or device capable to measure the intensity of the received light. Alternatively, a broadband light source 705 could be used, with a filter located at the detector 706. A multiple-wavelength integrated CMOS detector could also be used as the detector 706. Other possible optical components and configurations, known in the prior art, may be utilized that will attain the same goal of performing an absorbance measurement at specific wavelengths.

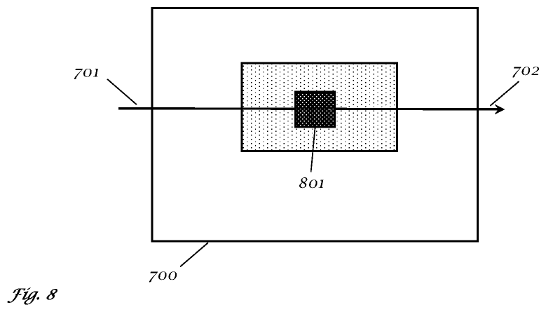

FIG. 8 shows another possible implementation of the sample analysis module 700, now including a module 801 for performing electrochemical measurements, in accordance with an embodiment of the invention. Such a module may include a fluidic cavity, as well as a specific geometry of electrodes. The electrodes may be functionalized with different chemicals so as to increase the specificity and sensitivity of the measurement. In one preferred embodiment, such electrodes could be manufactured in various metals using MEMS photolithographic techniques and metal evaporation, sputtering or atomic layer deposition.

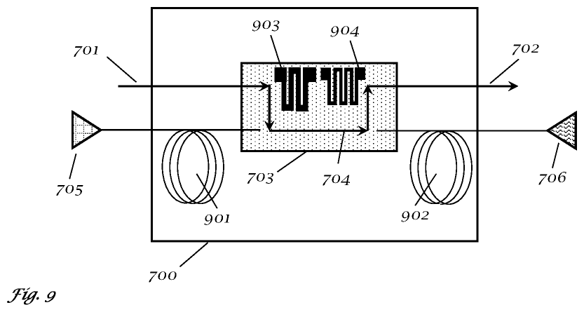

FIG. 9 shows another sample analysis module 700 for performing optical measurements, in accordance with an embodiment of the invention. In this configuration, the light source 705 and detector 706 may each be coupled to an individual optical fiber 901 and 902, which are then inserted and sealed inside the fluidic channel 704. The light emitted by the source 705 propagates along the optical fiber 901, enters the fluidic channel 704 at one extremity, propagates along the channel where it absorbed by the chemical components present in the sample stream, and then enters the optical fiber 902 to finally reach the detector 706.

In accordance with various embodiments of the invention, the fluidic device 703 may be a microfluidic chip manufactured, without limitation, using MEMS technology out of resilient materials such as glass and silicon, and the optical fibers 901 and 902 are adhesively bonded at either extremity of the straight channel, and coupled to the light source 705 and detector 706, respectively. In a related configuration, the microfluidic chip may be manufactured using hard plastic materials. These proposed configurations have the advantage of automatically aligning the optical fiber within the channel, and therefore with each other, which optimizes their coupling. Additional optical features can be included either in the channel geometry or in the optical fiber endings, such as collimating lenses or optical filters.

The fluidic device 703 may further include a heater 903 and a temperature sensor 904 that are coupled to a controller (not shown) in a closed feedback loop, which allows imposing and maintaining a desired temperature of the device, and thus controlling the reaction temperature. Manufacturing fluidic device 703 using MEMS silicon/glass technology has the added advantage of allowing heater and temperature sensor elements to be photolithographically patterned as thin metal films onto the same chip, thus achieving high functional integration.

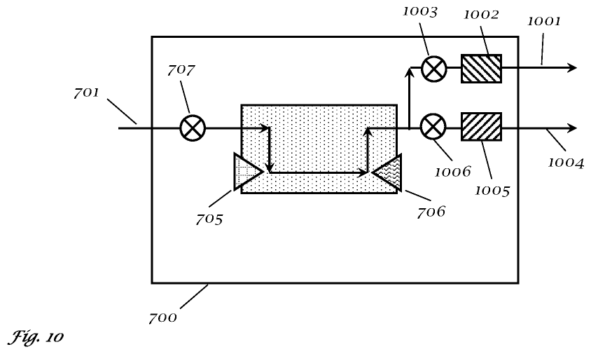

FIG. 10 is another possible implementation of the sample analysis module 700, showing two separate outlets 1001, 1004 that can be used for rapidly flushing the module, and, respectively, for collecting chemical waste, in accordance with an embodiment of the invention. The output of the sample analysis module may be directed to one of the two separate outlets 1001, 1004, using the valves 1003, 1006. Valve 1003, associated with a first (ideally lower) hydraulic resistance 1002 and with the clean outlet 1001, will allow rapid passage of clean water without reagents so as to flush the sample analysis module. Valve 1006, associated with a second (ideally higher) hydraulic resistance 1005 and the waste outlet 1004, will be used while performing measurements with chemical reagents in controlled, low-flow conditions that minimize the resulting waste volume. The hydraulic resistances 1002, 1005 may be actual hardware components located within the sample analysis module, or they could result from combined hydraulic resistances of all components downstream from the sample analysis module. The output from the waste outlet 1004 may be optionally filtered using, for example, an activated carbon filter (not shown on FIG. 10), to remove chemical components from the waste stream.

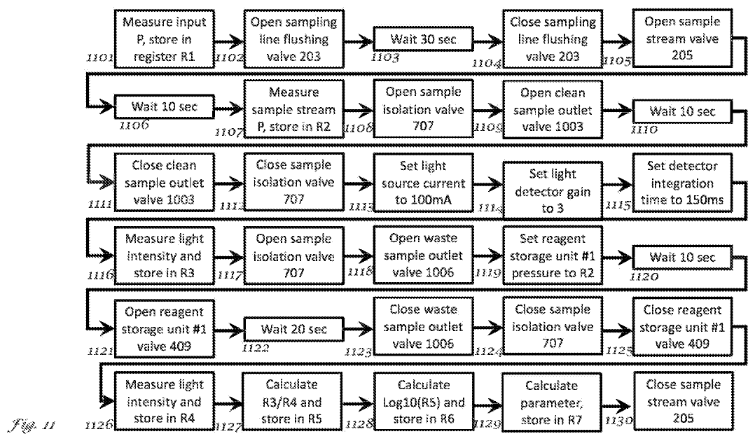

FIG. 11 shows an example of a program that starts by defining the sequence of individual operations for performing a specific measurement, that may be automatically read and executed by the analyzer, in accordance with an embodiment of the invention. It assumes that the analyzer is configured for sampling from a pressurized pipe (FIG. 2), and for performing optical measurements (FIG. 7). It assumes that the measurements require mixing of the sample with only one reagent, located in reagent storage unit #1, and does not require temperature control. It is assumed that the analyzer is in a state with all valves closed at the beginning of the program.

FIG. 11 starts at step 1101 by measuring and recording the pressure in the sampling pipe into the memory register R1. It then proceeds to a complete flushing of the sampling line, by opening valve 203, step 1102, waiting for 30 seconds, step 1103, then closing valve 203, step 1104. Now that the sampling line is flushed and the water sample in the line is representative, it opens the sample stream line, step 1105, allows it to equilibrate for 10 seconds, step 1106, and then records the fluidic sample pressure into memory register R2, step 1107. It then opens the isolation valve 707 of the sample analysis module, step 1108, directing its output towards the clean outlet by opening valve 1003, step 1109, and waits for 10 seconds, step 1110, until the sample analysis module is flushed. It then closes the valve 1003, step 1111, and also closes the isolation valve 707, step 1112. The program then configures the light source LED current to 100 mA, step 1113, sets the detector gain to 3, step 1114, and sets the integration time to 150 ms, step 1115. The light intensity is measured and stored in memory register R3 (this represents the blank value), step 1116. The isolation valve 707 is then opened again, step 1117, and the output is this time directed to the waste outlet by opening valve 1006, step 1118. The pressurization module is instructed to pressurize the reagent storage unit #1 to the pressure value stored in memory register R2 (the sample stream pressure previously recorded), step 1119, and the system then waits for 10 seconds for the pressures to stabilize, step 1120. The reagent valve 409 is then opened, step 1121, and the reagent is injected while the system waits for a duration of 20 seconds, step 1122. The valve 1006 is then closed, step 1123, and then the isolation valve 707 is closed, step 1124, as well as the reagent valve, step 1125. The system measures the light intensity again (this represents the measurement value) and stores it in memory register R4, step 1126. It then calculates the intensity ratio R3/R4 of the blank to the measurement value and stores it in memory register R5, step 1127, and calculates the base-10 logarithm of the ratio stored in memory register R5, which provides the absorbance value, which is stored in memory register R6, step 1128. From the absorbance value it then calculates the measured value of the desired chemical parameter, using stored calibration coefficients, and stores it in memory register R7, step 1129. The analyzer finishes its program by closing the sample stream valve 205, step 1130, which brings it back into the initial state. It is understood that this is only an example program, and that the exact sequence and values for the different configuration parameters have been selected for illustration purposes only. The person skilled in the art will understand that the flowchart of the program and the associated parameter values may be modified to fit a specific purpose or configuration of the analyzer.

The fluidic system described may be implemented using different types of technology and at different scales. One implementation is using microfluidic technology, which has the advantage of minimizing the overall size while greatly reducing the amount of sample and reagent required for each measurement. A small amount of stored reagent can consequently allow thousands of measurements to be performed before replenishing the reagent supply. Reducing reagent consumption not only has obvious cost benefits, but also environmental advantages by a proportional reduction in the generated chemical waste. In one embodiment of the present invention, shown in FIG. 1, the generated chemical waste stream 111 may be filtered through a filter 112, such as, for example, an active carbon filter, which would retain the organic compounds present in the waste stream, thus releasing a purified, clean output stream 113. Due to the high adsorption capacity of activated filters and to the minimal amounts of waste generated, a modest-size active carbon filter could be used for thousands of measurements without reaching saturation. Furthermore, the great size reduction that can be obtained through miniaturizing the fluidic system by using microfluidic technology results in reduced instrument sizes, which can be installed in space- and weight-constrained environments, such as on aerial drones, autonomous underwater vehicles, underwater gliders, unmanned surface vehicles, submarines, as well as in space applications. Finally, due to the resulting overall miniaturization resulting from use of microfluidic technology, all the subcomponents can operate on lower electrical power budgets, resulting in low power consumption and the possibility to deploy long-term autonomous measurement systems for days, weeks and months at a time.

The fluidic system described may be used to perform fluid analysis on any fluid sample, not necessarily for drinking water quality measurements but also, for example: in processing plants; in wastewater treatment plants; in space applications; in natural environments such as rivers; lakes and reservoirs; in stormwater conduits; in the ocean, at surface or at depth; in oilfield applications, including in downhole measurement tools. As shown in FIG. 1, the fluidic system 100 may communicate with remote equipment 109 via one of the many telemetry schemes known in the art, such as over electronic conductors, wireless networks, cellular networks, satellite communication, optical fibers or other suitable communication means to a server or other remote processing/data storage means 109; it may store the data retrieved from the sensors in the incorporated memory (not shown) to be later retrieved; or it may be transmitted wirelessly; or it may be downloaded to a local or remote computer.

It is to be understood that the system may be made modular in composition, which may provide various benefits such as ease of troubleshooting, repair and maintenance, ability to adapt to specific functional configurations or space constraints and better reliability.

Embodiments can be implemented in whole or in part as a computer program product for use with a computer system. Such implementation may include a series of computer instructions fixed either on a tangible medium, such as a computer readable medium (e.g., a diskette, CD-ROM, ROM, USB disk, flash memory, magnetic disk or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., radio waves, microwaves, infrared light or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A reagent delivery and analysis system for receiving and analyzing a fluidic sample, the system comprising:
one or more reagent storage containers for holding the same or different reagents;
a fluidic mixer coupled to the one or more containers, each container coupled to the fluidic mixer via a different reagent conduit, each reagent conduit including a valve controlling flow of reagent from the container to the fluidic mixer, the fluidic mixer further coupled to a fluid source, the fluidic mixer for homogenizing a fluidic sample from the fluid source with reagent;
a pressurization module for selectively applying a pressure to at least one of the one or more containers via a pressurization fluid that is kept separate from the sample fluid, and to the reagent in the one or more containers, the pressure causing reagent to flow from a selected container into the fluidic mixer.

2. The system according to claim 1, wherein each reagent conduit further includes a hydraulic resistor.

3. The system according to claim 1, further comprising a sample pressure sensor selected from one of a differential sample pressure sensor configured to measure the pressure difference between the fluid source entering the fluidic mixer and the ambient pressure, and an absolute pressure sensor configured to measure the pressure of the fluid source entering the fluidic mixer.

4. The system according to claim 3, wherein the pressurization module is configured to selectively apply pressure to at least one of the one or more containers that is calculated based on the pressure sensed by the sample pressure sensor.

5. The system according to claim 3, wherein each reagent conduit further includes a specific hydraulic resistor, and wherein the pressurization module is configured to selectively apply a pressure to at least one of the one or more containers so as to ensure a desired flow rate of the reagent through its associated hydraulic resistor into the fluidic mixer, and is at least partially based on the pressure measured by the sample pressure sensor and the value of the associated hydraulic resistor.

6. The system according to claim 1, further including a sample analysis module for analyzing the homogenized mixture of the fluid sample and the at least one of the one or more reagents.

7. The system according to claim 6, wherein each reagent conduit further includes a hydraulic resistor, and wherein the fluidic mixer, each hydraulic resistor, the sample analysis module, or combinations thereof include microfluidic devices with lateral channel dimensions between 1 and 1000 micrometers.

8. The system according to claim 7, wherein each reagent conduit further includes a hydraulic resistor, and wherein the fluidic mixer, each hydraulic resistor, the sample analysis module, or combinations thereof include devices manufactured using MEMS technology.

9. The system according to claim 1, whereas the pressurization fluid is a gas, the system further comprising a pressurized gas source coupled to an inlet port of a manifold, the manifold including a pneumatic pressure sensor configured to measure the pressure of the gas in the manifold, the manifold including a pressure release port for allowing the gas to escape the manifold, the manifold further including one or more outlet ports that are pneumatically coupled to the one or more containers.

10. The system according to claim 9, where the manifold further includes on-off valves for controlling pneumatic connectivity from the inlet port of the manifold to the pressure release port and to the one or multiple outlet ports, said on-off valves being controlled by the pressurization module based, at least in part, on the measured pressure of the gas in the manifold.

11. The system according to claim 10, where the pressurized gas source includes an air pump, the air pump controlled by the pressurization module so as to maintain a predetermined pressure setpoint value at the pneumatic pressure sensor.

12. The system according to claim 1, where each container is positioned within a pressure housing, the pressurization fluid applying pressure to the pressure housing which in turn is transmitted to the reagents.

13. The system according to claim 12, where the pressure housing further includes a separator between the reagent and the pressure fluid that prevents their contact but still allows the transmission of the pressure from the pressurization fluid to the reagent.

14. The system according to claim 13, where the compliant separator includes one of a compliant partition and a threaded bag.

15. A method of receiving and analyzing a fluidic sample in which one or more reagent storage containers are coupled to a fluidic mixer, each container coupled to the fluidic mixer via a different reagent conduit, each reagent storage container configured to hold the same or different reagent, the method comprising:
controlling flow of a sample fluid from a fluid source into the fluid mixer;
selectively applying a pressure to at least one of the one or more containers via a pressurization fluid that is kept separate from the sample fluid, and to the reagent in the one or more containers, the pressure causing reagent to flow from a selected container into the fluidic mixer; and
homogenizing, by the fluidic mixer, the sample fluid with reagent.

16. The method according to claim 15, wherein each reagent conduit is associated with a valve controlling flow of the reagent from the container to the fluidic mixer, the method further comprising controlling the valve to allow flow of the reagent from the container to the fluidic mixer.

17. The method according to claim 15, wherein each reagent conduit further includes a hydraulic resistor.

18. The system according to claim 15, further comprising measuring a sample pressure selected from one of a differential sample pressure between the fluid source entering the fluidic mixer and the ambient pressure, and an absolute pressure of the fluid source entering the fluidic mixer.

19. The method according to claim 18, wherein selectively applying a pressure to at least one of the one or more containers includes applying a pressure that is calculated based on the sample pressure.

20. The method according to claim 18, wherein each reagent conduit further includes a specific hydraulic resistor, and wherein selectively applying a pressure to at least one of the one or more containers includes ensuring a desired flow rate of the reagent through its associated hydraulic resistor into the fluidic mixer, and is at least partially based on the sample pressure and the value of the associated hydraulic resistor.

21. The method according to claim 15, further including analyzing the homogenized mixture of the fluid sample and the at least one of the one or more reagents.

22. The method according to claim 15, wherein selectively applying a pressure to at least one of the one or more containers via a pressurization fluid that is kept separate from the sample fluid includes:
coupling a pressurized gas source to an inlet port of a manifold, the manifold including a pressure release port for allowing the gas to escape the manifold, the manifold further including one or more outlet ports that are pneumatically coupled to the one or more containers, the manifold further including on-off valves for controlling pneumatic connectivity from the inlet port of the manifold to the pressure release port and to the one or multiple outlet ports;
measuring the pressure of the gas in the manifold; and
controlling said on-off valves based, at least in part, on the measured pressure of the gas in the manifold.

23. The method according to claim 22, where the pressurized gas source includes an air pump, the method further comprising controlling the air pump so as to maintain a desired pressure setpoint value in the manifold.

24. The method according to claim 15, where each container includes a pressure housing, and wherein selectively applying a pressure to at least one of the one or more containers via a pressurization fluid includes applying pressure to the pressure housing which in turn is transmitted to the reagents.

25. The method according to claim 24, where the pressure housing further includes a separator between the reagent and the pressure fluid that prevents their contact but still allows the transmission of the pressure from the pressurization fluid to the reagent.

26. The method according to claim 25, where the compliant separator includes one of a compliant partition and a threaded bag.
